(19) United States
(12) Patent Application Publication
(10) Pub. No.: US 2010/0203965 A1
(43) Pub. Date: Aug. 12, 2010

(54) Display device, system and methods for a craps table

(75) Inventors: Scott M. Juds, Seattle, WA (US); James H. Halsey, El Dorado, AR (US)

Correspondence Address: SPEED LAW FIRM, 111 CENTER STREET, SUITE 1200, LITTLE ROCK, AR, 72201, US

(73) Assignee: IDX, Inc., El Dorado, AR (US)

(21) Appl. No.: 12/660,176

(22) Filed: Feb. 22, 2010

Related U.S. Application Data
(63) Continuation-in-part of application No. 11/744,212, filed on May 3, 2007.
(60) Provisional application No. 60/797,777, filed on May 3, 2006.

(51) Int. Cl. A63F 13/00

(52) U.S. Cl. 463/31

(57) ABSTRACT

Embodiments include a device, system and method for display for a craps table. In one example, a display may include a display portion operable to display a representation of data relating to a current die pair rolled by a shooter; and a display portion operable to display a representation of data relating to previous die pairs rolled. In one example, the representation of the data relating to the current die pair includes a graphic representation of the face of each die of the current die pair. A display may also include a display portion operable to display an indicator of a current point value of the craps game. Other features and embodiments are disclosed herein.

### CROSS-REFERENCE TO RELATED APPLICATIONS

This application is a continuation-in-part of co-pending U.S. patent application Ser. No. 11/744,212, filed May 3, 2007, which claims benefit of U.S. provisional patent application Ser. No. 60/797,777, filed May 3, 2006. Each of the aforementioned related patent applications is herein incorporated by reference.

### BACKGROUND OF THE INVENTION

1. Field of the Invention

The present invention relates generally to electronic displays.

2. Description of the Related Art

A craps game is a popular casino game involving a craps table and a shooter who rolls a pair of dice. Based on the outcome of each roll made by the shooter and the current “point,” certain payouts or events can occur. The game's administrative staff for a craps game can include a box man, two dealers, and a stick man, the stick man charged with gathering the dice after they have been rolled and returning them to the shooter.

The two dealers take bets and put them on a layout in pre-designated spots on the craps table, collecting losing bets and paying out winning bets. The box man oversees the game to make sure it is properly conducted. The stick man stands at the middle of the table opposite the box man and dealers, and holds a long stick with a hook end. With the stick, the stick man collects the pair of dice and moves them to the shooter.

As recognized by the present inventors, what is needed is a display for a craps table which provides historical data which a player or an observer can easily read and understand.

It is against this background that various embodiments of the present invention were developed.

### SUMMARY OF THE INVENTION

In light of the above and according to one broad aspect of one embodiment of the present invention, disclosed herein is a display for a craps table that displays historical data of dice that have been rolled.

In one example, the display may include a display portion operable to display a representation of data relating to a current die pair rolled by a shooter; and a display portion operable to display a representation of data relating to previous die pairs rolled. In one example, the representation of the data relating to the current die pair includes a graphic representation of the face of each die of the current die pair. A display may also include a display portion operable to display an indicator of a current point value of the craps game.

In one embodiment, a display may also include one or more indicators indicating a winning die pair; and/or one or more indicators indicating a change in a shooter.

According to another broad aspect of another embodiment of the present invention, disclosed herein is a system for a craps table. In one embodiment, the system may include a keyboard operable to receive die pair data; and a display coupled with the keyboard, the display operable to display current and previous die pair data. In one example, the display of current and previous die pair data includes graphic representations of the faces of each die of the current and previous die pair data. The display may also include a display portion operable to display an indicator of a current point value of the craps game.

According to another broad aspect of an embodiment of the present invention, disclosed herein is a method of displaying information related to a craps game played at a craps table. In one example, the method includes providing a display associated with the craps table; obtaining data relating to a first die pair rolled by a shooter; storing the data relating to the first die pair; and displaying on the display a representation of the data relating to the first die pair.

In one example, the representation of the data relating to the first die pair includes a graphic representation of the numeric value of each die of the first die pair, or the representation of the data relating to the first die pair includes a graphic representation of the face of each die of the first die pair.

In one embodiment, the method may also include displaying on the display an indicator of a current point value of the craps game. The method may also include displaying on the display one or more indicators indicating establishment of a point value. The method may also include displaying on the display one or more indicators indicating a winning die pair. The method may also include displaying on the display one or more indicators indicating a change in a shooter.

In one embodiment, the method may also include obtaining data relating to a second die pair rolled by the shooter; storing the data relating to the second die pair; and displaying on the display a representation of the data relating to the second die pair. The representation of the data relating to the second die pair may be temporarily located in a position proximate a top of the display. If desired, the representation of the data relating to the first die pair may be located below the representation of the data relating to the second die pair. The method may also include reducing the size of the representation of the data relating to the first die pair so that the size of the representation of the data relating to the second die pair is larger than the size of the representation of the data relating to the first die pair. In one embodiment, the method may also include providing the representation of the data relating to the first die pair in a first color; and providing the representation of the data relating to the second die pair in a second color.

The features, utilities and advantages of the various embodiments of the invention will be apparent from the following more particular description of embodiments of the invention as illustrated in the accompanying drawings.

### BRIEF DESCRIPTION OF THE DRAWINGS

So that the manner in which the above-recited features of embodiments of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an example of a display attached to or associated with a craps table, in accordance with one embodiment of the present invention.

FIG. 2 illustrates an example of a display for a craps table, in accordance with one embodiment of the present invention.

FIG. 3 illustrates another example of a display for a craps table, in accordance with one embodiment of the present invention.

FIG. 4 illustrates an example of operations for displaying dice roll data in a display for a craps table, in accordance with one embodiment of the present invention.

FIG. 5 illustrates an example of operations for displaying a change in the shooter in a display for a craps table, in accordance with one embodiment of the present invention.

FIG. 6 illustrates a block diagram of an example of a system for providing a display for a craps table, in accordance with one embodiment of the present invention.

FIG. 7 illustrates an example of a keypad for controlling a display of a craps table, in accordance with one embodiment of the present invention.

FIG. 8 illustrates another example of a keypad for controlling a display of a craps table, in accordance with one embodiment of the present invention.

FIG. 9 illustrates a block diagram of a keypad for controlling a display for a craps table, in accordance with one embodiment of the present invention.

FIG. 10 illustrates an example of a circuit schematic for a keypad for controlling a display for a craps table, in accordance with one embodiment of the present invention.

FIG. 11 illustrates a top view of a craps table having a window surface therein, in accordance with one embodiment of the present invention.

FIG. 12 illustrates a block diagram of a dice value detection/recognition system with a sectional view of a portion of the craps table of FIG. 11, in accordance with one embodiment of the present invention.

FIG. 13 illustrates an example of operations for recognizing the value of a pair of dice rolled, in accordance with one embodiment of the present invention.

FIGS. 14A-D illustrate examples of captured and processed images for dice value recognition, in accordance with one embodiment of the present invention.

FIG. 15 illustrates another example of positioning a display behind the boxman, in accordance with one embodiment of the present invention.

FIG. 16 illustrates another example of a display for a craps table, in accordance with one embodiment.

FIG. 17 illustrates another example of a display for a craps table, in accordance with one embodiment.

FIG. 18 illustrates another example of a display for a craps table, in accordance with one embodiment.

FIG. 19 illustrates another example of a display for a craps table, in accordance with one embodiment.

FIG. 20 is a table showing the probability of a state after a roll.

FIG. 21 is a table showing the probability of a particular state after a roll is completed.

FIG. 22 is a chart showing dice roll probabilities.

FIG. 23 illustrates an example of operations for displaying a last consecutive roll number for the current shooter in a field in a display for a craps table, in accordance with one embodiment.

### DETAILED DESCRIPTION

Disclosed herein is an electronic display for a craps table that dynamically shows historical data of the dice pair rolls that have occurred during the game. Various embodiments of the present invention are disclosed herein.

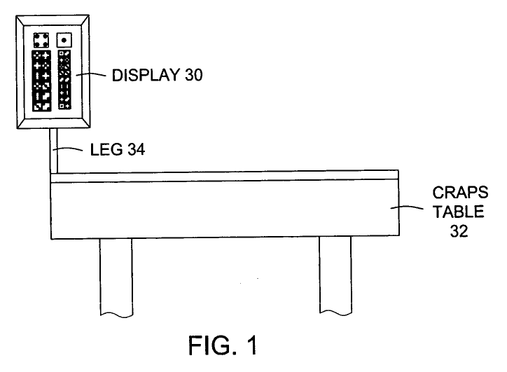

In FIG. 1, a display 30 showing historical dice roll data (hereinafter “dice pair roll data”) may be, in one example, attached to a conventional craps table 32. The display 30 can have one or more features that are disclosed herein. In one example, the display 30 may be attached through a support arm or leg 34 that is positioned about the end or edge or side of the craps table 32, and the display 30 is positioned above the top edge of the table so that the display is easily viewable by one or more players or observers of the craps game being played at the craps table 32. In another example, the display 30 could be positioned so that it is positioned in the middle of the table 32, wherein the arm/leg 34 is upwardly extending from the middle of the surface of the craps table 32. In another example, the display 30 could also be positioned above the craps table 32, for example suspended from the ceiling or attached to a column or wall, if desired.

In another example, the display 30 can be provided as a stand-alone display (which is not secured to the table), wherein the display 30 is mounted on a stand so that the display 30 is positioned at a height viewable to players and observers of the craps game. For instance, the stand-alone display can be positioned approximately 5 to 7 feet or higher above the ground to facilitate viewing, and can be positioned behind the boxman, if desired (i.e., so as to reduce the amount of space consumed by the display 30 around the craps table 32 where players would otherwise stand).

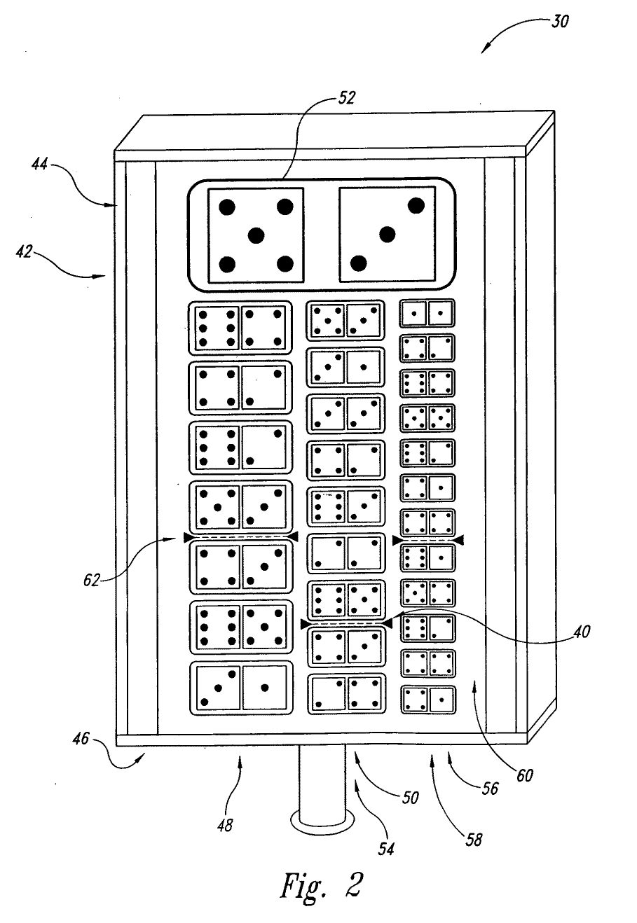

FIG. 2 illustrates an example of a display 30 for a craps table, in accordance with one embodiment of the present invention. In one example, the display 30 includes at least one active display screen 40, and historical data relating to the dice that have been rolled during a craps game are displayed on the active display screen portion 40 of the display 30. A display 30 may include two, three, or four or more active display screens, depending upon the number of sides the display has in a particular implementation. For instance, a four-sided display (not shown) may be provided with one active display screen 40 per side, totaling four active display screens in this example. In one example, a craps table display 30 may have a generally rectangular box shape and may be formed of anodized aluminum extrusion cases, a sheet metal enclosure, or other conventional material.

An active display screen 40 of a display 30 may include a plurality of indicia 42, 46, 54, 58 representative of rolled dice values. A first indicia 42 can be displayed corresponding to the numeric values of a first and second die (hereinafter the “dice pair”) that have been most recently rolled, shown in FIG. 2 as the current roll 52. In one example, the first indicia 42 includes a graphical representation of the face of each die of a pair of dice. For example, in FIG. 2, the first indicia 42 includes a graphical representation of a pair of dice, wherein the first die was a five and the second dice was a three. In another example, the first indicia 42 may include a first and second number which correspond to the numeric value of the first and second die. For instance in FIG. 2, the first indicia 42 could be represented as a pair of numbers, such as 5, 3.

One benefit of the use of indicia which include graphical representations of the dice (such as shown in FIG. 2) is that the graphical representations of the dice provide the information to an observer as if the observer were watching the rolls of dice at the craps table 32. For instance, in a display 30 such as the example of FIG. 1, it is easy for an observer to review the display 30 and see that a roll occurred that had pair of dice having the same number, such as a pair of sixes, a pair of ones (snake eyes), etc.

Preferably, the first indicia 42 of the current roll 52 is positioned near the top of the active display screen area 40, and is displayed within a first area 44 which is larger than other indicia, described below.

Historical dice pair roll data can be displayed in a number of ways. In one example, historical dice pair roll data is displayed in one or more of columns, as shown in FIG. 2. A first set of indicia 46 can be presented in the active display screen 40, wherein the first set of indicia 46 include a plurality of representations of pairs of prior dice rolls. This first set of indicia 46 may be arranged in a vertical column arrangement 48, wherein more recent dice pair roll data are displayed higher within a column 48 than older dice pair roll data.

In one example, the display of dice pair roll data is displayed wherein the most recent dice pair roll data is displayed at the top of the active display screen 40, the second most recent dice pair roll data (older than the most recent dice pair roll data) is displayed below the most recent dice pair roll data, the third most recent dice pair roll data is displayed below the second most recent dice pair roll data, the fourth most recent dice pair roll data is displayed below the third most recent dice pair roll data, and so on. In this manner, an observer can easily see the history of the rolled dice of a craps game.

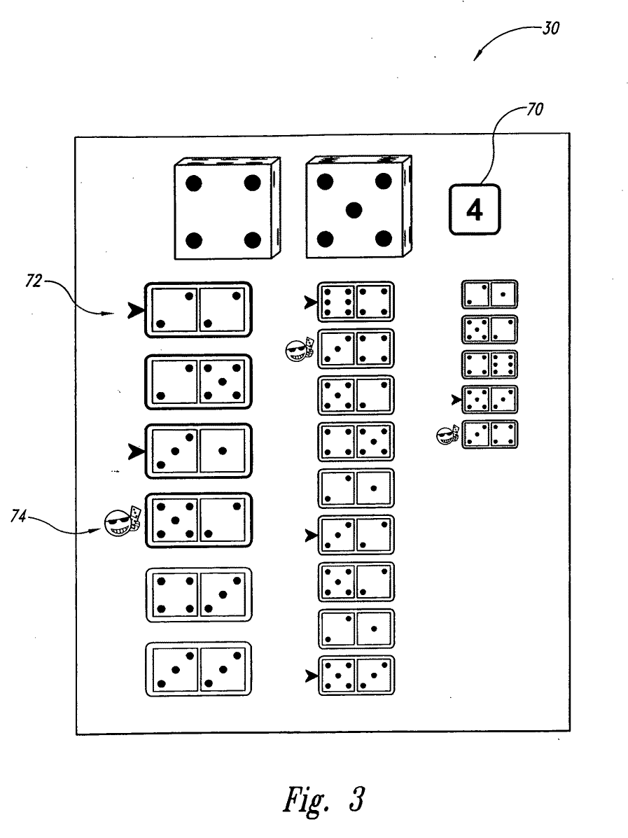

In one example, in the first column of historical dice pair roll data 48, the first set of indicia 46 are each sized to occupy a second area per piece of historical dice pair roll data. The second area for each piece of historical dice pair roll data in the first column 48 can be sized smaller than the first area which is used to display the current roll value 52 (i.e., each second area occupied by a representation of a dice pair roll data can be smaller than each first area, as shown in FIGS. 2-3).

A second column of historical dice pair roll data 50 may be provided and positioned adjacent to the first column 48. The top entry of the second column 50 may include the historical dice pair roll data which immediately preceded in time the value of the dice pair roll data indicated at the bottom element of the first column 48, in one example. As with the first column 48, the second column 50 may also be arranged in chronological order such that the older historical dice pair roll data are displayed below more recent historical dice pair roll data within the second column 50.

Each of the second set of indicia 54 in the second column of historical dice pair roll data 50 may occupy a third area, the third area being smaller than the second area of the first column. In this way, the older dice pair roll data are displayed using smaller amounts of area in the display, which make the display easily understandable to a viewer (i.e., each third area occupied by a representation of a dice pair roll data can be smaller than each second area, as shown in FIGS. 2-3).

A third column of historical dice pair roll data 56 may be included in an active display screen 40 of a craps table display 30, and may be positioned adjacent to the second column 50. As shown in the example of FIG. 2, the third column 56 may include, at the top of the third column 56, the value of the historical dice pair roll data which immediately proceeded in time the value of the dice pair roll data indicated at the bottom element of the second column of historical dice pair roll data 50. As with the first and second columns, the third column 56 may also be arranged in chronological order such that the older historical dice pair roll data are displayed below more recent historical dice pair roll data within the third column 56. Each of the third set of indicia 58 in the third column of historical dice pair roll data 56 may occupy a fourth area, the fourth area being smaller than the third area of the second column 50 (i.e., each fourth area occupied by a representation of a dice pair roll data can be smaller than each third area, as shown in FIGS. 2-3).

In operation, as new dice pair roll data is received for display, each of the values in the display 30 shift downward in general within a single column, and any data displayed at the bottom of a column is shifted to be displayed at the top of the next column (except for the oldest piece of dice pair roll data, which is dropped from the display if the display was full). For instance, in the example of FIG. 2, the most recent dice pair roll data 52 is shown as 5, 3; the next most recent dice pair roll data is shown at the top of the first column 48 as 6, 4, and six rolls prior to that, the dice pair roll data of 3, 1 is displayed at the bottom of the first column 48, followed by dice pair roll data 5, 3 displayed at the top of the second column 50, followed eight rolls later by 2, 4 which is displayed at the bottom of the second column 50, followed by 1, 1 which is displayed at the top of the third column 56, followed eleven rolls later by the oldest roll data 60 of 4, 1 displayed at the bottom of the third column 56.

When new dice pair roll data is received and displayed in the active display screen 40, the most recent roll data of 5, 3 moves to the top of the first column 48, and each of the dice pair roll data shifts downward within the first column 48 by one position, except that the value of 3, 1 which occupied the bottom of the first column 48 is now displayed (in smaller format, in one example) at the top of the second column 50. The dice pair roll data in the second column 50 are also shifted downward by one position, except that the dice pair roll data of 2, 4 which occupied the bottom location in the second column 50 will then be displayed (in smaller format, in one example) at the top of the third column 56, and the dice pair roll data in the third column 56 will be shifted downward by one position. The lowest or last entry of dice pair roll data 60 displayed at the bottom or lowest portion of the third column 56 will no longer be displayed when the display is full, as it will be replaced with the dice pair roll data immediately above it, in one example (i.e., 4, 1 will be replaced with 4, 4 in the example of FIG. 2).

In another embodiment, the arrangement of the historical dice pair roll data can be reversed, so that most recent dice pair roll data is displayed near the bottom of the active display screen 40, and the older dice pair roll data information is displayed in sequence upwardly toward the top of the active display screen 40.

As shown in the example of FIG. 2, a display 30 may also be provided with an indicia 62 indicating a new shooter or different shooter of a craps game. In FIG. 2, the new shooter indicia 62 is shown as a pair of arrows with a dashed line therebetween, although other indicia may be utilized to indicate that the shooter changed between the adjacent dice pair roll data. It can be seen that there have been four different shooters in this example, the first transition between shooters occurred when a first shooter rolled a 6, 1, and thereafter the second shooter's first roll was 4, 4. The second shooter's final roll was 4, 3, and that shooter was replaced by a third shooter whose first roll was 6, 5. The third shooter's final roll was a 4, 3 and the fourth/current shooter's first roll was a 5, 3. The fourth/current shooter's most recent roll was 5, 3.

By indicating the transition of shooters through use of some form of an indicia on the display, embodiments of the present invention provide an observer with the ability to easily see the historical dice pair roll data that the present shooter has rolled, as well as the historical dice pair roll data for one or more prior shooters.

In another embodiment, changes of the shooter may be indicated by changing the color of the indicia of the dice pair roll data within the active display screen 40. In one example, the color of the dots of the dice roll data corresponding to a first shooter are displayed in a first color; the color of the dots of the historical dice pair roll data of a second shooter are displayed in a second color; the color of the dots of the dice of the historical dice pair roll data of a third shooter are displayed in a third different color; etc. In another example, the color of the dice themselves, and/or an outline or highlight color for each piece of historical dice pair roll data in the display may uniquely indicate and correspond to different shooters.

FIG. 3 illustrates another example of a display 30 for a craps table 32, in accordance with one embodiment of the present invention. In FIG. 3, a field 70 is provided for displaying the current “point” value in the craps game. The “point” is the number that, once established, needs to be rolled again before a seven is rolled in order to win a pass line bet. The point can be a 4, 5, 6, 8, 9 or 10, traditionally. An indicia 72 (shown as an arrowhead) can be provided which is pointed at the historical dice pair roll data which established the point, and this indicia 72 may be retained and associated with this historical dice pair roll data as the data scrolls through the display as other new rolls are displayed. In one embodiment, if the current roll established a new “point” value, then an arrowhead or other indicia can be indicated next to the current roll display field.

In another embodiment as shown in FIG. 3, an indicia 74 can be provided for showing a winning roll and can be associated and retained the historical dice pair roll data as the data scrolls through the display as other new rolls are displayed. A display 30 can be provided, which can include one or more of the features of FIG. 2 or FIG. 3 or as otherwise disclosed herein or variations thereof.

In one example, the display 30 may include a display portion 42/52 operable to display a representation of data relating to a current die pair rolled by a shooter; and a display portion 46 operable to display a representation of data relating to previous die pairs rolled. In one example, the representation 42/52 of the data relating to the current die pair includes a graphic representation of the face of each die of the current die pair. A display may also include a display portion 70 operable to display an indicator of a current point value of the craps game.

In one embodiment, a display 30 may also include one or more indicators 74 indicating a winning die pair; and/or one or more indicators 62 indicating a change in a shooter.

In one embodiment and as described below, a system for a craps table may include a keyboard operable to receive die pair data; and a display coupled with the keyboard, the display operable to display current and previous die pair data. In one example, the display of current and previous die pair data includes graphic representations of the faces of each die of the current and previous die pair data. The display may also include a display portion operable to display an indicator of a current point value of the craps game.

A method of displaying information related to a craps game played at a craps table is also disclosed herein. In one example, the method includes providing a display 30 associated with the craps table 32; obtaining data relating to a first die pair rolled by a shooter; storing the data relating to the first die pair; and displaying on the display 30 a representation of the data relating to the first die pair. In one example, the representation of the data relating to the first die pair includes a graphic representation of the numeric value of each die of the first die pair, or the representation of the data relating to the first die pair includes a graphic representation of the face of each die of the first die pair. In one embodiment, the method may also include displaying on the display 30 an indicator of a current point value of the craps game. The method may also include displaying on the display 30 one or more indicators indicating establishment of a point value. The method may also include displaying on the display 30 one or more indicators indicating a winning die pair. The method may also include displaying on the display 30 one or more indicators indicating a change in a shooter.

In one embodiment, the method may also include obtaining data relating to a second die pair rolled by the shooter; storing the data relating to the second die pair; and displaying on the display a representation of the data relating to the second die pair. The representation of the data relating to the second die pair may be temporarily located in a position proximate a top of the display. If desired, the representation of the data relating to the first die pair may be located below the representation of the data relating to the second die pair. The method may also include reducing the size of the representation of the data relating to the first die pair so that the size of the representation of the data relating to the second die pair is larger than the size of the representation of the data relating to the first die pair.

In one embodiment, the method may also include providing the representation of the data relating to the first die pair in a first color; and providing the representation of the data relating to the second die pair in a second color.

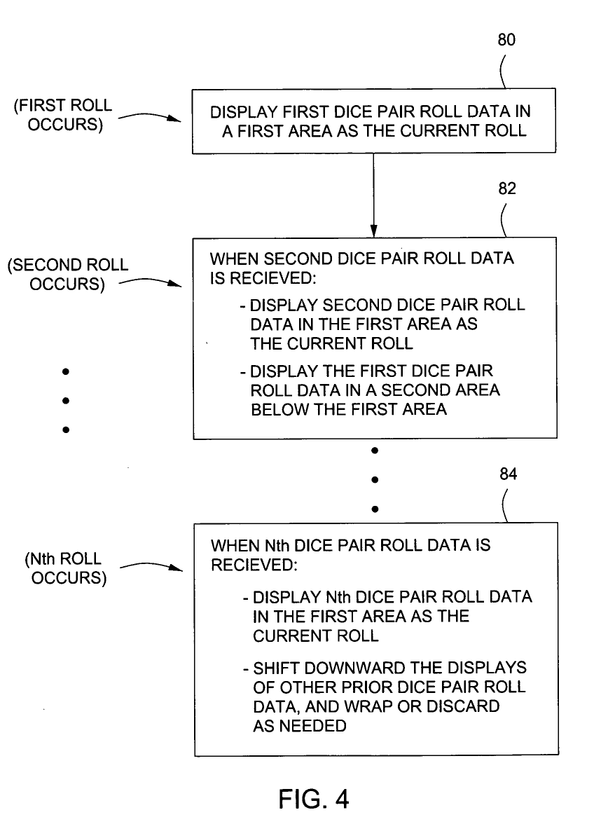

FIG. 4 illustrates an example of operations for displaying dice roll data in a display 30 for a craps table 32, in accordance with one embodiment of the present invention. At operation 80, after a first roll occurs, the first dice pair roll data is displayed in a first area of the display 30 as the current roll 52. As mentioned above, if the current roll established a new point then an arrowhead or other indicia can be indicated next to the current roll display field.

At operation 82, after a second roll occurs, the second dice pair roll data is displayed in a first area of the display 44 as the current roll 52, and the display of the first dice pair roll data can be shown adjacent to (i.e., below) the first area 44 of the current roll display field. This process continues as additional rolls occur. For instance at operation 84, after the Nth roll occurs, the Nth dice pair roll data is displayed in a first area of the display as the current roll, and the display of the (N−1) dice pair roll data can be shown adjacent to (i.e., below) the first area of the current roll display field. The displays of the other prior dice pair roll data are shifted (i.e., downward) and if applicable wrapped to the top of the next column if a multi-column display format is used. If the display was full of data, then the oldest piece of historical dice pair roll data 60 is discarded and removed from the display 30.

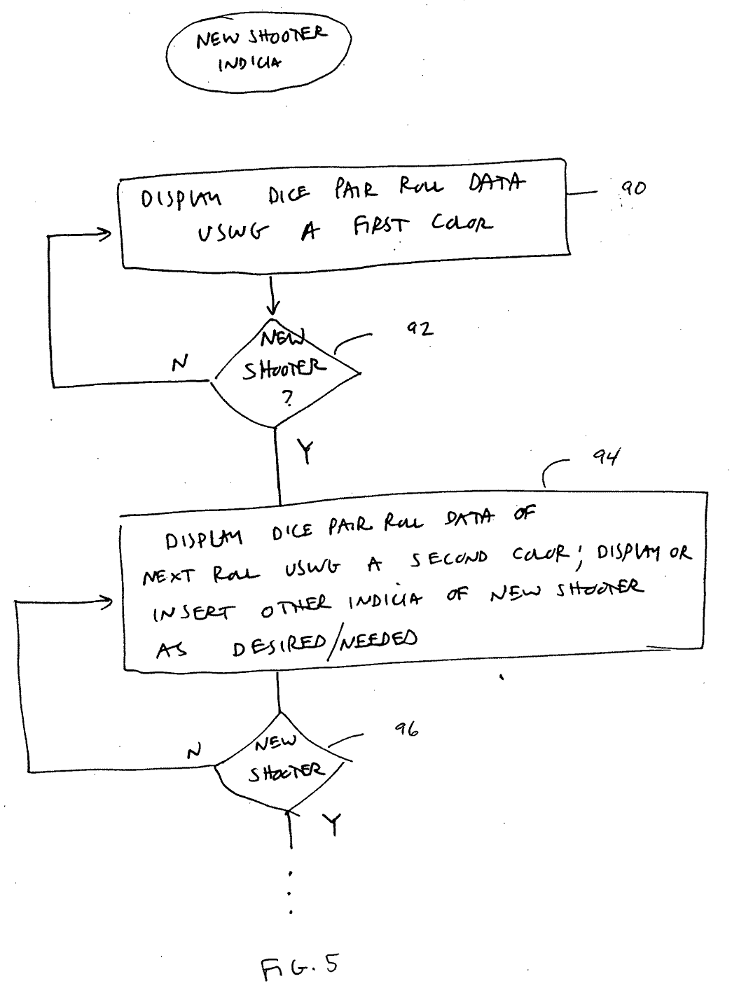

FIG. 5 illustrates an example of operations for displaying a change in the shooter in a display 30 for a craps table 32, in accordance with one embodiment of the present invention. At operation 90, a display of dice pair roll data is presented using a first color. Operation 92 determines whether a shooter has changed (for instance, as flagged by the stickman or other person using a keypad, as described below), and if not, the display of the next dice pair roll data in the display can use the same color as in operation 90. If operation 92 detects a change in the shooter, then control is passed to operation 94 wherein the display of the next dice pair roll data is shown using a different color than used in operation 90.

Operation 96 determines whether a shooter has again changed (for instance, as flagged by the stickman or other person using a keypad, as described below), and if not, the display of the next dice pair roll data in the display can use the same color as in operation 94, otherwise if the shooter has changed, then another color can be used for display of the next dice pair. In this way, the colors of the dice pair roll data in the display 30 can be used to indicate a change in the shooter, if desired.

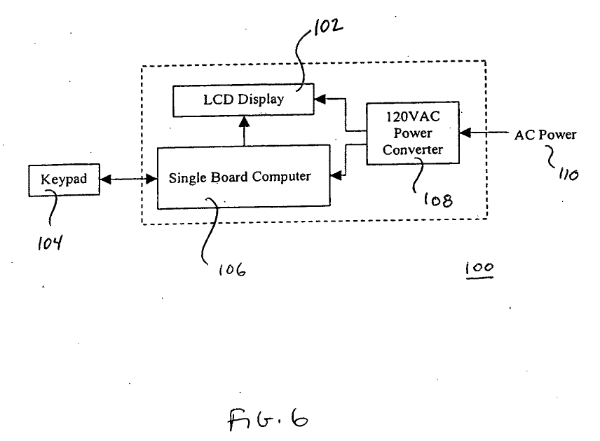

Disclosed herein are various embodiments of display systems that can be used with a craps table. FIG. 6 illustrates a block diagram of an example of a system 100 for providing a display 30 for a craps table 32, in accordance with one embodiment of the present invention. In one example, a display system 100 for a craps table 32 may include a display 102 (as described with regard to any embodiment disclosed herein) coupled with or in communication with a keyboard 104 (used to enter dice pair roll data or other commands such as “change shooter”), and a computer 106 (such as but not limited to a single-board computer, a micro-controller or microprocessor, or other programmable logic or state machine or processor, and these terms are used interchangeably herein). The computer 106 is coupled with and controls a display 102, such as an LCD display, and is also coupled with the keypad 104 to read the data or commands from the keypad 104, such as dice pair roll data. Based on the data or commands received from the keyboard 104, the computer 106 controls the display of information on the display 102.

A display driver (not shown) may be provided, either as part of the display 102 or as part of the computer 106, depending upon the implementation. A power supply/converter/regulator 108 can be utilized in order to provide power to the system. In one example, AC power 110 is utilized for the system, and a power converter 108 (which converts AC power to DC power) may be utilized in order to provide power to the display 102, computer 106, and keypad 104, in one example. In another example, DC or battery power is utilized to provide power to one or more elements of the system. Any conventional means of providing power may be utilized with the system.

In one example, the keypad 104 is coupled with the computer 106 via a serial communications link, including, but not limited to, serial communication protocols such as USB, RS232, or any conventional link or protocol, including wired or wireless communication links that may be encrypted/secured if desired. Likewise, the display 102 may be coupled with the computer 106 over wired or wireless links, as desired.

In one example, the computer 106 reads the button depressions on the keyboard 104, or receives data related thereto, creates one or more events or changes of state based thereon in order to change the display 102 in a manner responsive to the particular keypad depressions. The computer 106 may implement one or more of the operations or features described herein, including tracking state of the display, storing historical data that is to be written to the display, etc. If desired, the display 102 can be provided with the functionality of the computer 106, or such functionality can be integrated within the keypad 104, if desired, depending upon the implementation.

The computer/controller 106 of FIG. 6 may include of a diskless single board computer that may, for example, use MS Windows or Linux as an operating system running from Flash RAM having application software written, for example, in MS Visual Basic to provide for serial port communication with the keypad 104 to generate the graphics to be shown on the LCD display 102. A single board computer 106 simplifies the engineering development of the system 100 by leveraging the high level communication and display services provided with such a relatively high performance computing platform and enjoying the relatively low cost. In another embodiment, the computer/controller 106 of FIG. 6 can be a microcontroller, programmable logic device, custom ASIC or other conventional processor.

The display 102 may be an LCD display, such as a 22″ diagonal LCD22IR by Miller Technologies. In this application, the LCD 102 display is oriented with its tall axis in the vertical direction to better display the information. Any conventional display 102 could be used, utilizing any conventional display technology, depending upon the implementation. As mentioned above, multiple displays may be included in the display device 30 (i.e., one display on the front side of the display device 30, another display on the back side of the display device 30).

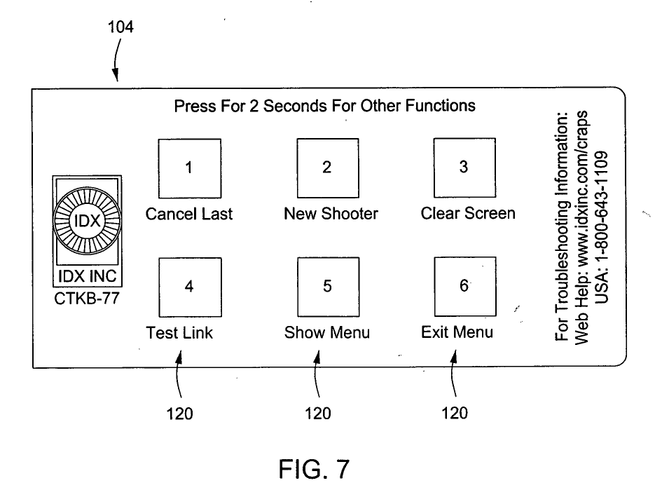

The keypad 104 may include, in one example, six keys or characters 120, as shown in FIG. 7. In FIG. 7, each key 120 of the keypad 104 corresponds to a value of a single die. For instance, if a pair of dice were rolled and the value rolled was 2, 6, then the keyboard or keypad 104 could be depressed with 2 and 6 in order to display this dice pair roll data. In another example, one or more of the buttons 120 of a keypad 104 may activate a function or command, for example if the button 120 is pressed and held for a predetermined about of time (i.e., pressed and held for 2 seconds or more, in one example). For instance, a “cancel last” function may be provided, wherein the last dice pair roll data entry is canceled. This function may be useful in the event that there is a data entry error that needs to be corrected. For instance, if the data entered was 2, 6, but in fact should have been 2, 5, the cancel last function can be activated so that the display of 2, 6 is canceled and the data of 2, 5 can be entered and displayed.

In another embodiment, a “new shooter” function can be provided wherein when a button 120 of the keypad 104 (such as the “2” button is depressed and held for at least 2 seconds) then the keypad 104 sends data or a message indicating that the a new shooter has been indicated, so that the display 30 can be modified to provide or illuminate a new shooter indicia, as described above.

In another embodiment, a “clear screen” function may be provided in order to clear the historical dice pair roll data from an active display screen 40.

In one example, the keypad 104 may have multiple modes of operation—Normal Mode may be associated with usual game play, Command Mode may provide additional control capability to the operator, and Menu Mode may be provided for setup and diagnostic functions. In Normal Mode, the stickman, boxman or other person is expected to press two buttons to convey to the display controller which dice have been rolled. As each button is pressed, it becomes lit to indicate it has been pressed. In one example, if a second button is not pressed within 2 seconds, the LED in the first button is turned back off and the sequence is reset. When the values for the two die have been entered and after second button has been pressed, a message sent to the display controller (not shown). In one example, the message may include a prefix ASCII character “D” and the ASCII characters representing number of each of the buttons pressed. The response is either ACK or NAK, wherein the latter will cause re-transmission of the same message. In one example, the LED for the second button can be kept on for example for a minimum of 500 ms, and then will either turn off then simultaneously with the first button LED, or remain turned on until a NAK is received, or for seconds, whichever is shorter. If the same button is pressed twice (such as when the shooter rolls a pair of 4's, the button can blink at a faster rate (i.e., 8 times per second) during the time until it is to be turned off.

In another embodiment, other features such as providing a menu can be included. A menu mode may be provided having various menu functions depending upon the particular implementation. A test function may also be provided if desired, which may, for example, be used to test a communications link between the keypad and other components, such as a controller or display, if desired.

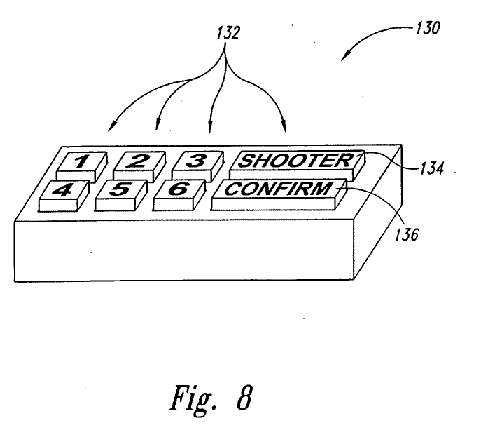

FIG. 8 illustrates another example of a keypad arrangement 130, in accordance with one embodiment of the present invention. In this example, six numeric keys 132 are provided, as well as a “shooter” button 134 which can be utilized to change the shooter; as well as a “confirm” button 136 which can be used to confirm data entry, in one example.

In one example, each time the dice are rolled the stickman, boxman or other person inputs the results into the keypad 130. The buttons may be back lighted and can toggle on and off with repeated hits to enable correction of an erroneous button presses. When the correct numbers are lighted on the keypad, the Confirm button 136 is pressed to send the information to the display 30. The Shooter button 134 is pressed to indicate when there is a new shooter. To cancel the previous input to the display 30, the Confirm button 136 can be held down for at least 5 seconds (or other time value, depending on the implementation). To clear the display 30 completely to indicate the start of new daily session, the power can be cycled to the unit, or in one example the Shooter button 134 can be held down for at least 5 seconds or other time value depending on the implementation.

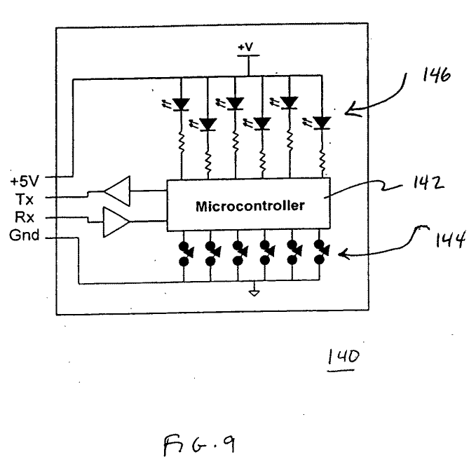

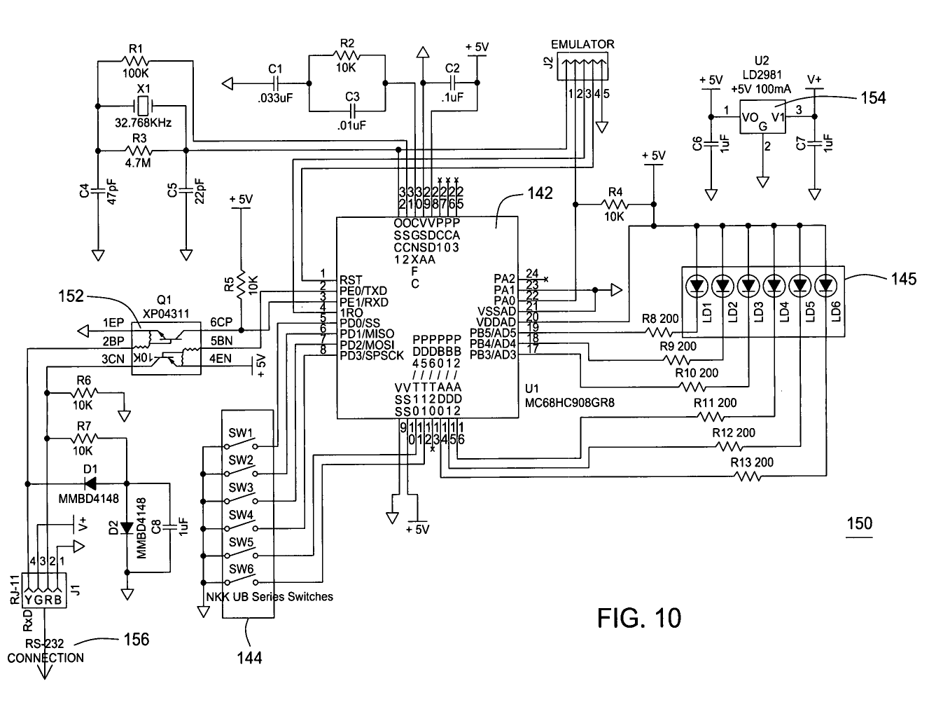

FIG. 9 illustrates a block diagram 140 of a keypad 104 for controlling a display 30 for a craps table 32, and FIG. 10 illustrates an example of a circuit schematic 150 for a keypad for controlling a display for a craps table, in accordance with one embodiment of the present invention. A keypad 104 may include a micro-controller 142, six switches 144 as inputs to the micro-controller, six LEDs 146 which can be used to selectively illuminate or backlight the buttons of the keypad 104 (these LEDs configured as outputs of the micro-controller). The keypad 104 may also include a serial communication interface chip 152, such as a UART coupled with the micro-controller 142. The UART interface 152 provides for RS232 interface communications with the computer 106 of FIG. 6, in one example.

As by way of example only, the keypad may communicate to the display controller through an RS-232 serial link 156. The cable may use a 4-wire interface having +5V power, ground, transmit (Tx) and receive (Rx), and having an RJ-11 (telephone style) connector, in one example. The keypad 104 may have a microcontroller 142 such as the Freescale MC68HC908GR8 which has parallel port pins suitable for controlling the six resistor-biased LED indicators 146 and six push button switches 144. The push button switches 144 can be connected to parallel port pins configured with internal pull-up resistors such that when a button 120 is pressed the port pin goes low and may be detected by the firmware of the microcontroller 142. Each of the indicator LEDs 146 can be located within the pushbutton and indicates the status of the pushed button to the operator. The microcontroller 142 may have an internal UART 152 transmitting messages to, and receiving messages from, the display controller 106. An electrical interface may be established through a buffer transmitter and receiver such as the MAX232 from Maxim.

In another embodiment, the keypad 104 may be implemented as a wireless keypad, such as in the form of a handheld device, and may be in communications with the display over any conventional wireless link, such as Bluetooth for example.

Depending on the implementation, the data entry of the dice pair roll data may be performed, using a keypad 104, by the stickman or other person, in accordance with one embodiment of the present invention.

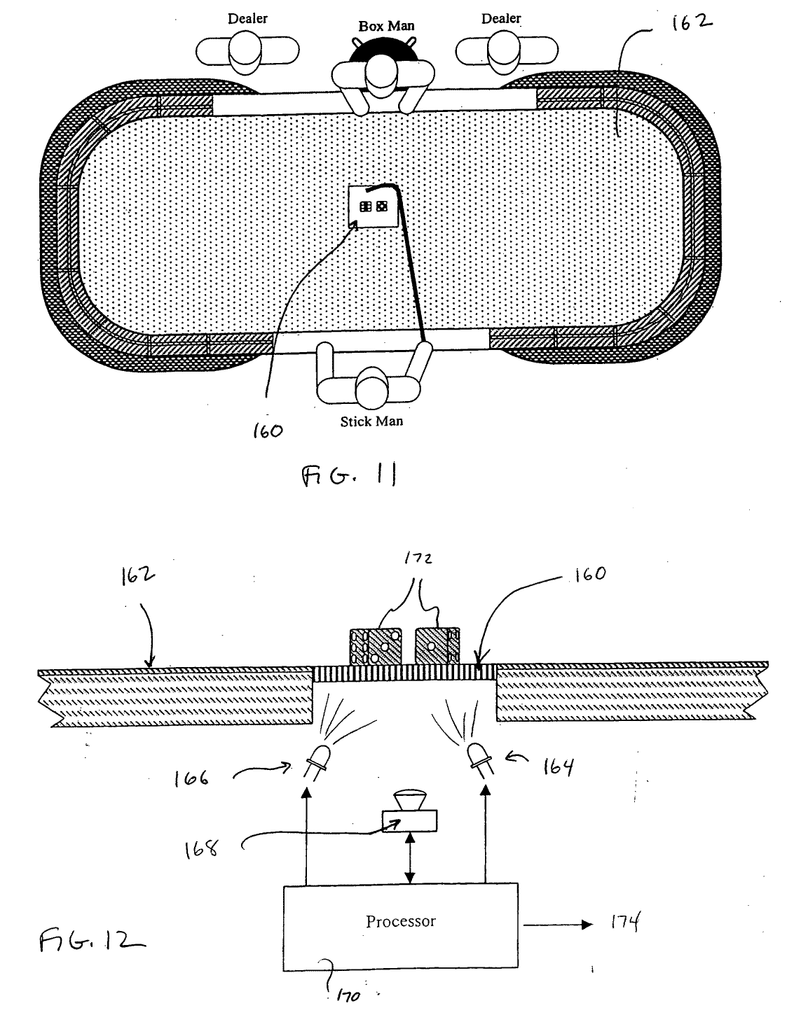

In another embodiment, a dice detection/recognition system may be utilized as an alternative mechanism for providing dice pair roll data, as shown in FIGS. 11-14. In one example, the craps table 32 is provided with a translucent or transparent area, window or surface 160 where the rolled dice may be positioned momentarily (FIGS. 11-12). Because all dice have a fixed relationship between the bottom side and top side, a dice recognition system can determine the dice pair roll data by examining the dice from the bottom side thereof.

In one example, controllable illumination may be provided which can be selectively enabled or disabled beneath the surface of the craps table 162 to illuminate the dice from below the table through the window 160. FIG. 12 illustrates an example of a cross-section of a craps table 32 having a transparent window 160 along its surface 162, one or more light sources or transmitters 164, 166, and one or more detectors 168. The light transmitters 164, 166 and detectors 168 may be coupled with a processor 170 which controls the transmitters 164, 166 and reads the data provided by the detector 168. The processor 170 could, in one example, read the data from the bottom side of the dice 172, and determine what the proper dice pair roll data 174 is to be displayed, as well as communicate that information to the display 30 directly or indirectly.

In one example, the window 160 may be transparent to infrared light. In one example, the window 160 may have a deep red dyed color to a visual black color, infrared transmissive type such as GE Lexan with dye color 21092. The lights 164, 166 can be infrared LEDs (i.e., Siemens SFH487P) used to illuminate the dice from below through the window 160. The image capture device 168 may include any conventional camera or image capturing device, such as a USB camera. Algorithms for background subtraction and edge finding are well known in the art. Identification and counting of individual objects is also well known in the art. Thus identifying the individual die and counting the number of spots on each utilizes techniques well understood to those experienced in the art of image recognition.

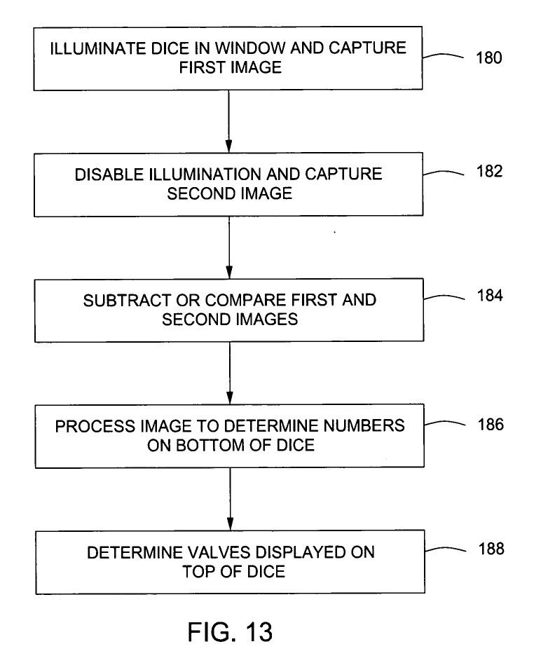

FIG. 13 represents an example of operations which may be performed in order to detect the value of a pair of rolled dice, in accordance with one embodiment of the present invention. At operation 180, having the dice positioned within the window 160, the illuminators 164, 166 may be enabled and an image may be captured of the illuminated dice 172. At operation 182, the illuminators 164, 166 may be disabled/turned off, and an image of the dice 172 with the illuminators disabled may be captured. The order of operations 180 and 182 may be changed, depending upon the implementation.

Having captured images of the dice 172 with the bottom side of the dice illuminated and not illuminated, these images may be manipulated in order to determine the value of the dice pair roll data. At operation 184, a pixel-by-pixel difference between the images obtained by operations 180, 182 can be generated, which in effect subtract the background from the images of operations 180, 182. At operation 186, an edge finding algorithm or other conventional image processing algorithm, may be utilized to determine the value displayed on the bottom side of each of the die.

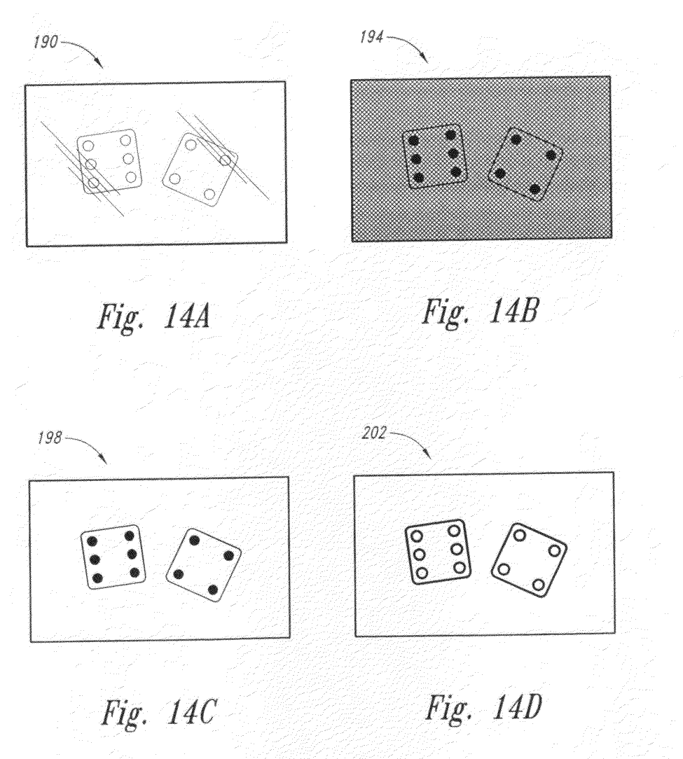

FIG. 14A shows an example of a captured image 190 of the bottom of a pair of dice 172 when illuminated; FIG. 14B shows an example of a captured image 194 of the bottom of a pair of dice 172 when not illuminated; FIG. 14C shows an example 198 of the difference between FIGS. 14A and 14B; and FIG. 14D shows an example 202 of a the results of an edge finding process.

Based on the value displayed on the bottom of each die, at operation 188 of FIG. 13, the value of the dice pair roll data can be determined. The following mapping may be used by operation 188 to determine the value of the roll:

TABLE 1
Mapping between Bottom-side Die values and Top-side Die values

| Bottom-side Die reading | Top-side Die value |
|---|---|
| 1 | 6 |
| 2 | 5 |
| 3 | 4 |
| 4 | 3 |
| 5 | 2 |
| 6 | 1 |

Once the value of a pair of rolled dice 172 is determined, the processor 170 of FIG. 12 can transmit the dice pair roll data to the computer/display 102, 106 for presentation on the display 30.

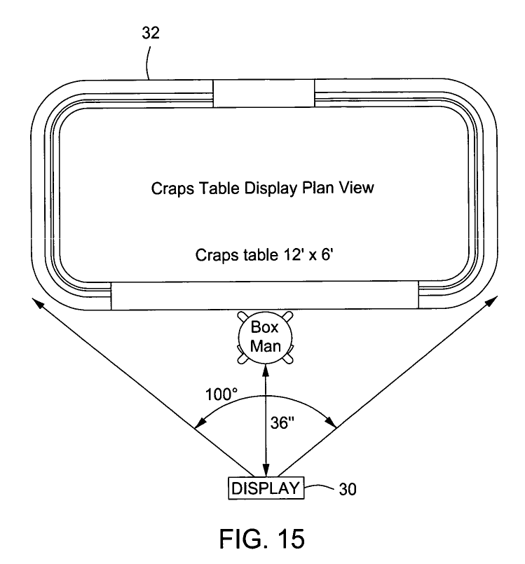

FIG. 15 illustrates another example of positioning a display behind the boxman, in accordance with one embodiment of the present invention. For instance, in one example, the display can be positioned behind the boxman (i.e. approximately three feet behind the boxman) so as to create a wide viewing angle of the display (i.e., approximately 100 degree viewing angle). In this manner, the display can be seen by many of the players positioned about the craps table.

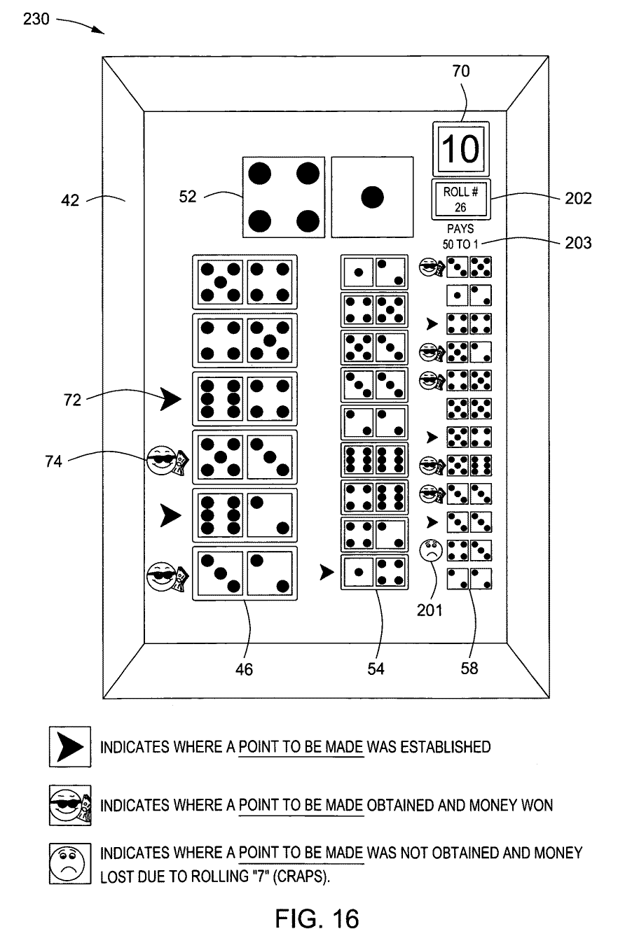

FIGS. 16-19 depict another embodiment of a craps table display 230 which may be usable in addition to or in lieu of the display 30 described herein. The components and operation of the craps table display 230 are essentially the same as the components and operation of the craps table display 30 as described herein, including possible variations and other embodiments of the craps table display 30, except as described in the next few paragraphs. For example, the current roll 52, the field 70 for displaying the current point value, the indicia 72 which is pointed at the historical dice pair roll data which established the point, the plurality of indicia 42, 46, 54, and 58, and the indicia 74 for showing the winning roll (for example, as shown in FIG. 16, and the indicia 74 for showing the winning roll may include a smiley face), which are shown and described in relation to the display 30, include the same features and operate in essentially the same manner as the same components of the display 230.

Referring now to FIG. 16, the display 230 may additionally include an indicia 201 showing the losing roll. The indicia 201 is substantially the same in operation and functionality to the indicia 62 indicating a new shooter or different shooter of a craps game. The indicia 201 may include, for example, a sad smiley face or frowning face and dashed line between adjacent dice pair roll data to indicate that the shooter lost roll of the dice (e.g., by rolling “craps” (a “7”)).

When a shooter loses roll of the dice and must pass the dice on to the next shooter, this may be termed “falling off.”

Additionally, as described above in relation to the display 30, changes of the shooter may be indicated by changing the color of the indicia of the dice pair roll data within the active display screen. For example, the color of the dots of the dice roll data, the color of the dice themselves, and/or an outline or highlight color for each piece of historical dice pair roll data in the display may be different for different shooters.

The field 70 for displaying the current point value in the craps game (the current point value to be made, before rolling a “7,” in order to win) is configured and operates substantially as described in relation to the field 70 of the display 30. In some embodiments, the field 70, including the number disposed in the field (which is the current point value) and/or the border of the field 70, may optionally change in color to correspond with the color assigned to the current shooter.

In the embodiments shown in FIGS. 16-19, the display 230 may include a field 202 for displaying the last consecutive roll number for the current shooter. In one example, the field 202 may include a rectangular border having disposed therein wording such as “ROLL #” on a first line and the last consecutive roll number for the current shooter (in the example shown in FIG. 16, the number is “26”) disposed numerically below the wording. In the example shown in FIG. 16, the current shooter has rolled 26 consecutive rolls (all shown in the dice pair roll data on the display 230).

The display 230 may also include a field 203 for displaying payout after a predetermined number of rolls of the dice by the same shooter without that shooter losing roll of the dice (falling off). In one example, this field 203 may include the word “PAYS” and the payout numbers below that word. In an example, the displayed payout in the field 203 is flashing (but in other examples, it remains on the screen without flashing or temporarily or intermittently appears on the screen). In one example, the payout may only be displayed on the display 230 after 7, 16, and/or 28 consecutive rolls of the dice by the same shooter without that shooter losing roll of the dice. In this example, the following payouts may be displayed: after 7 consecutive rolls of the dice by the same shooter, the payout is 2 to 1 (and the field 203 may show “PAYS 2 to 1”); after 16 consecutive rolls of the dice by the same shooter, the payout is 8 to 1 (and the field 203 may show “PAYS 8 to 1”); and after 28 consecutive rolls of the dice by the same shooter, the payout is 50 to 1 (and the field 203 may show “PAYS 50 to 1”). Although not shown, this field 203 may also optionally include a border as is shown on the fields 70 and 202, and the fields 202 and 203 may optionally change colors with a change in shooter to correspond with the color used for the current shooter on other locations on the display 230.

In operation, the display 230 shown and described in relation to FIGS. 16-19 may facilitate play of a game based on whether the same shooter will roll the dice a predetermined number of times (also termed the “roll spot”) before losing roll of the dice (losing roll of the dice occurs when the shooter rolls a “7” (craps)). One or more people, such as one or more casino customers, may place one or more bets on the predetermined roll spot and be paid an amount determined by the predetermined odds payout if the same shooter reaches that predetermined roll spot prior to losing roll of the dice.

An example of operation of the display 230 and of a game which may be played using the display 230 is described in relation to FIG. 16. The display 230 shows the current roll 52. In this example, the same shooter has rolled 26 consecutive rolls, as evidenced by the color of the dice of the current roll 52 and the subsequent rolls displayed after the indicia 201 showing the losing roll (the first column 46, second column 54, and the portion of the third column 58 disposed above the indicia 201 dice pair displays are located after the indicia 201), as well as evidenced by the field 202 for displaying the last consecutive roll number for the current shooter which shows “ROLL # 26.” The first roll for the current shooter was the dice showing the numbers 3, 3, and the last roll of the current shooter was 4, 1.

The order of events which occurred at the craps table is shown on the display 230 and is easily discernable to a person looking at the display 230, even if that person was not present at the craps table to watch the previous actual rolls of the dice. According to the display 230 shown in FIG. 16, the previous shooter rolled a 2, 2 and then subsequently lost roll of the dice upon rolling a 4, 3 totaling “7”, or “craps.” The indicia 201 showing the losing roll designates this lost roll of the dice by the 4, 3 rolled by the previous shooter. Any additional previous rolls to the 2, 2 and 4,3 of the previous shooter are no longer shown on the display 230 because newer rolls are shown on the display 230 as they occur, causing the previous rolls to eventually disappear from the display 230 to make room for newer rolls.

The display 230 also shows that the first roll of the current shooter was 3, 3. The color of the border, dice, and/or fields 70, 202, and/or 203 may optionally change upon change of the shooter, specifically, in this example, these colors may change from a first color indicating the previous shooter's rolls (2, 2 and 4,3) and a second color indicating the current shooter's rolls (all of the rest of the shown rolls). Additionally, upon change in the shooter, the roll number in field 202 changes to “ROLL # 1” when the new shooter accomplishes the first roll of the dice (the first roll of the new shooter in the example of FIG. 16 is 3, 3). As shown by the indicia 72 pointed at the dice pair roll data that established the point, the point to be made was established as “6” (the total of the 3, 3 dice pair) at this time in the craps game. At this point in time, the field 70 for displaying the current point value would have shown “6.” Upon completion of each consecutive roll by the same shooter, the number in field 202 changes to match the number of consecutive rolls by the current shooter (e.g., the second 3, 3 shown as rolled would cause the field 202 to read “ROLL # 2”, the 5, 6 roll would cause the field 202 to read “ROLL #3”, etc.).

The second roll of the current shooter was a 3, 3 also, according to the display 230. Because the total of this dice pair is “6,” the point to be made was made by this winning roll. The indicia 74 indicates at this second roll of the dice by the current shooter that a winning roll was made. Also after this roll, the field 202 would read “ROLL # 2”.

The additional rolls after the second roll of the current shooter are shown on the display 230 with similar indicia and update the roll number field 202 and the current point to be made field 70 in much the same way.

In one embodiment, prior to a first roll of a shooter, a person may place a bet on a desired roll spot, betting on whether the shooter will reach that number of consecutive rolls of the dice without losing possession of the dice (craps). The roll spots may be any desired number of consecutive rolls by the current shooter without losing possession of the dice, preferably predetermined roll spots by the casino or craps table proprietor. Additionally, the payout at the particular roll spot(s) upon consecutive roll of the dice by the same shooter without losing possession of the dice may be predetermined by the casino or craps table proprietor. In one example, the rolls spots are as follows:

| Roll Spot | Payout |
|---|---|
| 7 | 2 to 1 |
| 16 | 8 to 1 |
| 28 | 50 to 1 |

These consecutive roll spots and payouts translate to the following: After the current shooter completes 7 consecutive rolls without losing roll of the dice (craps), any person who made a bet on the 7 roll spot is entitled to a payout of 2 to 1 on that bet. Likewise, after the current shooter completes 16 consecutive rolls without losing roll of the dice (craps), any person who made a bet on the 16 roll spot is entitled to a payout of 8 to 1 on the bet. Also, after the current shooter completes 28 consecutive rolls without losing roll of the dice (craps), any person who made a bet on the 28 roll spot is entitled to a 50 to 1 payout on the bet.

In the example shown on the display 230 of FIG. 16, the seventh consecutive roll by the current same shooter was 5, 2. Because the current same shooter retained possession of the dice after this roll and did not lose roll of the dice (even though this roll is a total of “7,” a point to be made was not yet rolled, so this roll was not “craps” and the dice possession was not lost by the current shooter in this instance), anyone who placed a bet on the seven roll spot won. After the seventh consecutive roll of the dice by the current same shooter, the payout field 203 will display “PAYS 2 to 1” in this example, indicating that the payout should occur to anyone who placed the bet on the seven roll spot. Also, the field 202 will read “ROLL # 7”.

Similarly, in the example shown on the display 230 of FIG. 16, the sixteenth consecutive roll by the same current shooter was 3, 3 (shown in the second column 54). Because the current same shooter retained possession of the dice after this roll and did not lose roll of the dice, anyone who placed a bet on the sixteen roll spot won. After the sixteenth consecutive roll of the dice by the current same shooter, the payout filed 203 will display “PAYS 8 to 1” in this example, indicating that the payout should occur to anyone who placed a bet on the sixteen roll spot. Also, the field 202 will read “ROLL # 16”.

Finally, in the example shown in FIG. 16, when the twenty-eighth consecutive roll by the same shooter is completed without the shooter losing possession of the dice and losing roll of the dice, anyone who placed a bet on the 28 roll spot will win, the payout field will display “PAYS 50 to 1,” and the field 202 will show “ROLL # 28”.

In some embodiments, any bet(s) on the roll spots must be made prior to the first throw of the dice by the shooter on which the bets are placed. Some embodiments may allow a person to place bets on one or more of the roll spots, while other embodiments may limit the number of roll spots on which persons may place bets. Although not limiting of embodiments disclosed herein, a minimum bet amount may be established by the casino or craps table proprietor, such as one dollar per roll spot per person betting.

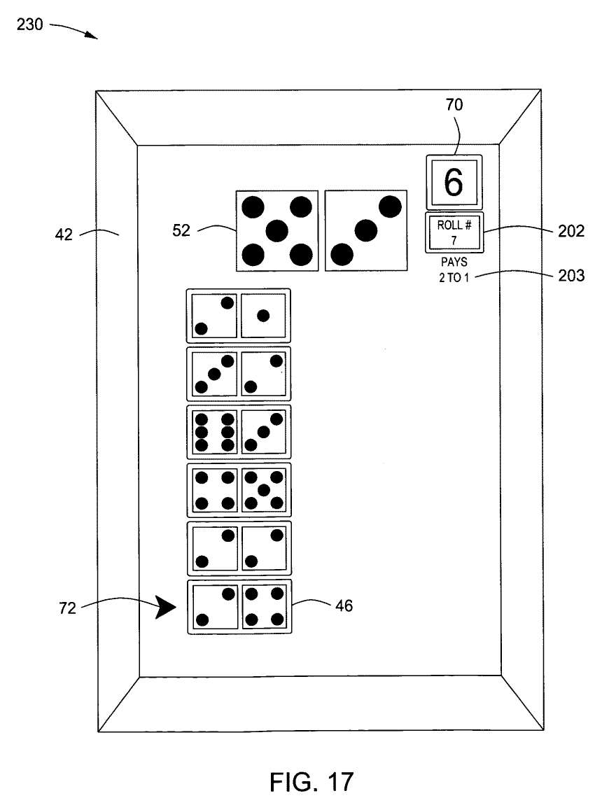

FIGS. 17-19 show an example progression of a craps game and its associated display 230 according to embodiments. Referring first to FIG. 17, a display 230 is shown providing an example of a displayed roll seven payout. The current shooter's current roll of 5, 3 is shown in the current roll 52 portion of the display. The previous rolls of this current shooter are shown beneath the current roll 52 in this example, where the dice pair of 2, 1 was rolled by the current shooter in the roll immediately previous to the current roll 52. The first roll of this current shooter was 2, 4, where the point to be made (in this instance a “6”) was established as shown by the indicia 72 on the display 230 which is disposed adjacent to the 2, 4 dice pair. At a designated time, in some embodiments prior to the first roll of the dice by the current shooter, any person may place a bet on the seven spot, sixteen spot, and/or 28 spot. In this example, any person(s) who placed a bet on the seven spot receive a payout of 2 to 1 after the current shooter rolls the 5, 3 shown in the current roll 52 portion of the display 230. The display 230 indicates that seven consecutive rolls were made by the current shooter without losing roll of the dice (shown by the colors of the seven dice pairs displayed on the display 230 being the same and/or shown by the “ROLL # 7” appearing in the roll number field 202). The display 230 also indicates that the payout of 2 to 1 on any bets made on the 7 roll spot should be disbursed (shown by the “PAYS 2 to 1” appearing in the payout field 203).

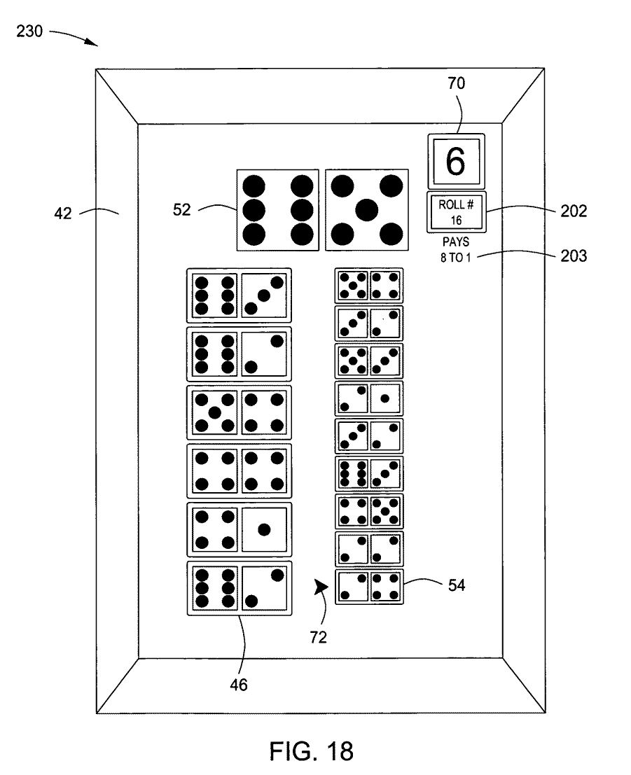

FIG. 18 illustrates the display 230 providing an example of a displayed roll sixteen payout. The dice roll data is displayed on the display 230, including that data which was collected in subsequent rolls to the roll seven payout illustrated in FIG. 17, as well as previous rolls of the dice by the current shooter. In FIG. 18, the dice pair of the current shooter's current roll 52 is shown as 6, 5. The previous rolls of this current shooter are shown beneath the current roll 52 in this example, where the dice pair of 6, 3 was rolled by the current shooter in the roll immediately previous to the current roll 52. The point of “6” remains displayed in the field 70 showing the current point value because this point has not yet been made by the current shooter, and the color of the field 70 and dice roll data remains the same as the color of the field 70 and dice roll data depicted in FIG. 17 because the same shooter is currently in possession of the dice and has not yet lost roll of the dice. In this example, any person(s) who placed a bet on the sixteen spot receive a payout of 8 to 1 after the current shooter rolls the 6, 5 shown in the current roll 52 portion of the display 230. The display 230 indicates that sixteen consecutive rolls were made by the current shooter without losing roll of the dice (shown by the colors of the sixteen dice pairs displayed on the display 230 being the same and/or shown by the “ROLL # 16” appearing in the roll number field 202). The display 230 also indicates that the payout of 8 to 1 on any bets made on the 16 roll spot should be disbursed (shown by the “PAYS 8 to 1” appearing in the payout field 203).

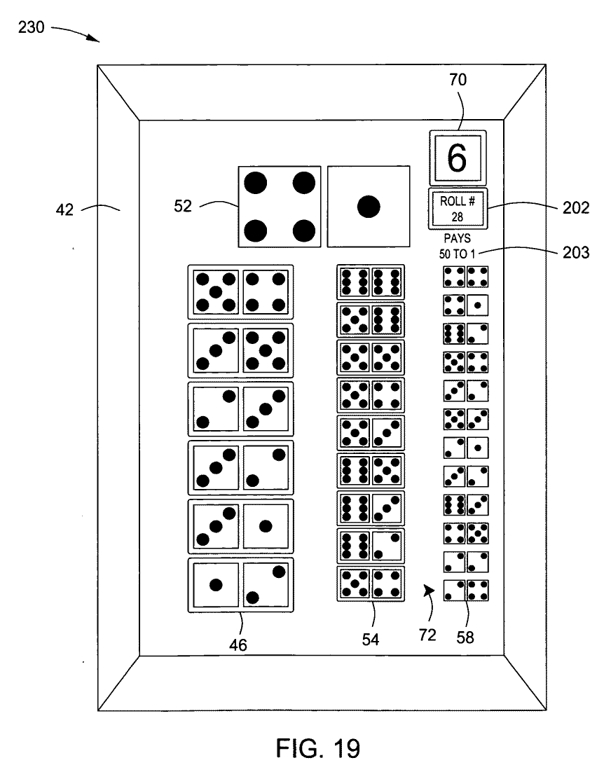

FIG. 19 illustrates the display 230 providing an example of a displayed roll twenty-eight payout. The dice roll data is displayed on the display 230, including that data which was collected in subsequent rolls to the roll sixteen payout illustrated in FIG. 18 as well as previous rolls of the dice by the current shooter. In FIG. 19, the dice pair of the current shooter's current roll 52 is shown as 4, 1. The previous rolls of this current shooter are shown beneath the current roll 52 in this example, where the dice pair of 5, 4 was rolled by the current shooter in the roll immediately previous to the current roll 52. The point of “6” remains displayed in the field 70 showing the current point value because this point has not yet been made by the current shooter, and the color of the field 70 and dice roll data remains the same as the color of the field 70 and dice roll data depicted in FIGS. 17 and 18 because the same shooter is currently in possession of the dice and has not yet lost roll of the dice. In this example, any person(s) who placed a bet on the twenty-eight roll spot receive a payout of 50 to 1 after the current shooter rolls the 4, 1 shown in the current roll 52 portion of the display 230. The display 230 indicates that twenty-eight consecutive rolls were made by the current shooter without losing roll of the dice (shown by the colors of the twenty-eight dice pairs displayed on the display 230 being the same and/or shown by the “ROLL # 28”appearing in the roll number field 202). The display 230 also indicates that the payout of 50 to 1 on any bets made on the 28 roll spot should be disbursed (shown by the “PAYS 50 to 1” appearing in the payout field 203).

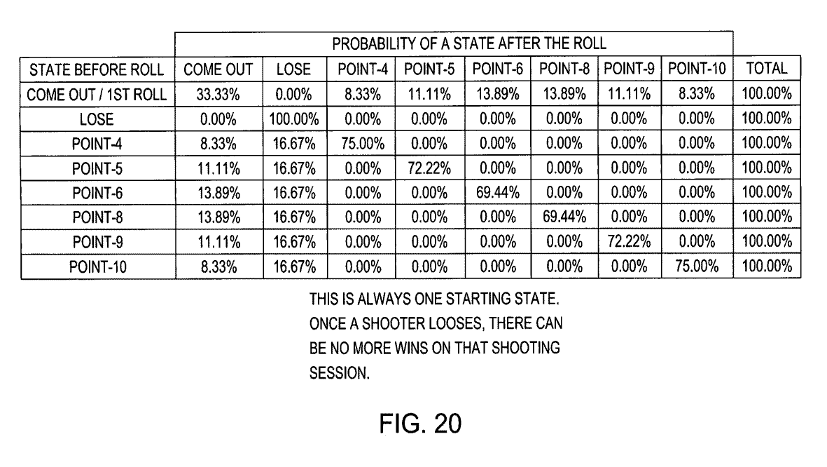

The exemplary payout amounts (2 to 1, 8 to 1, and 50 to 1) and roll spots (7, 16, and 28) were chosen for this example based on a calculation of the odds of winning a bet placed on the roll spots in a game of craps, the calculation using the probability of rolling particular dice pairs in a craps game. FIGS. 20-22 show tables and charts for calculating these odds and probabilities.

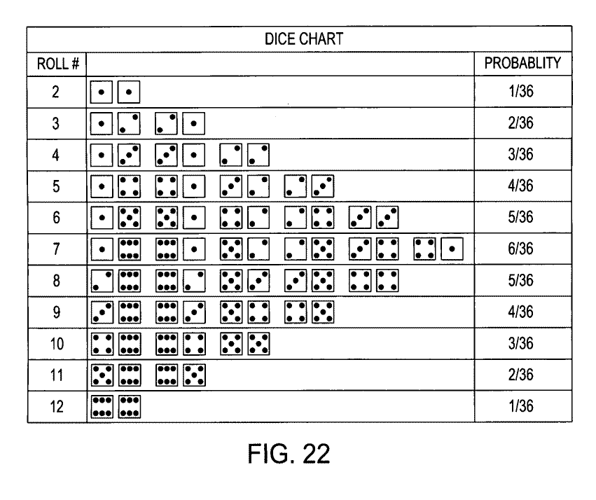

FIG. 22 is a chart showing dice roll probability. As shown in FIG. 22, the probability of a roll of a pair of dice resulting in a “2” when the numbers on each of the pair of dice are totaled is 1/36, the probability of a roll of a pair of dice resulting in a “3” when the numbers on each of the pair of dice are totaled is 2/36, etc., as indicated on the chart. This chart is based on each of the dice having the standard number of faces (6) and standard numbers 1 through 6 on each of their faces.

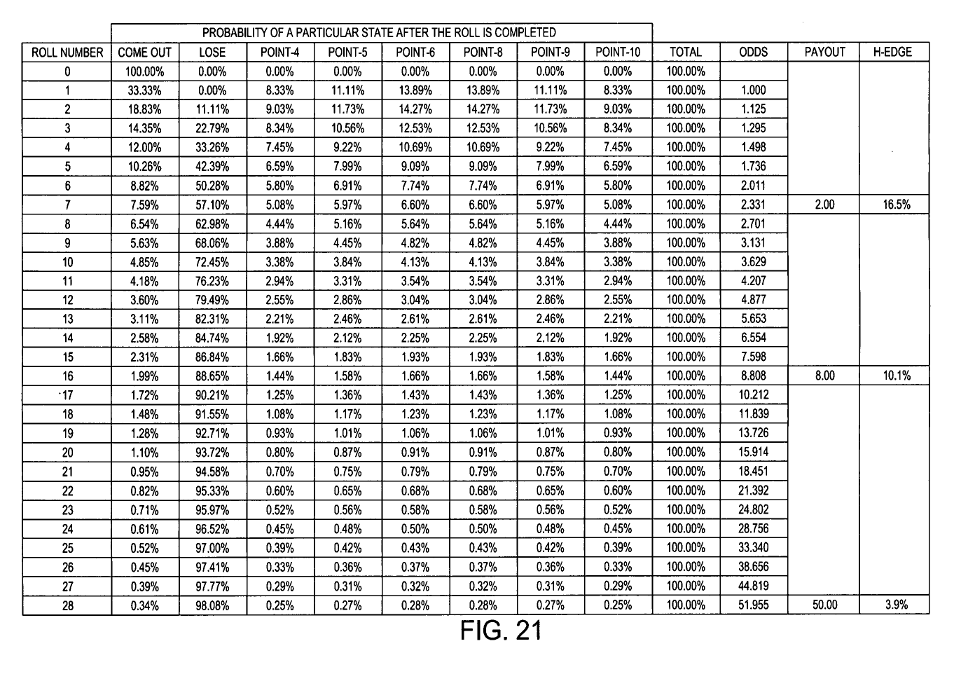

FIGS. 20 and 21 basically show spreadsheets of odds calculations of a side bet that could be made based on whether the current shooter can roll the dice at least a particular number of times before he or she must pass the dice on to the next shooter. Highlighted are the specific examples of at the least 7 times, at least 16 times, and at least 28 times illustrated in the foregoing description of FIGS. 16 through 19.

FIG. 20 is a table showing the probability of a state after a roll with respect to the state before the roll. The “state before roll” rows list the state of the craps game prior to a roll, while the “probability of a state after the roll” columns list the state of the craps game after that roll. The game starts with a first shooter who makes a “come-out roll” with the intention of establishing a point. If the come-out roll is a 2, 3 or 12, it is called “craps”, and the come-out roll continues. If the come-out roll is 7 or 11 is called a “natural,” and the come-out roll continues. The come-out roll continues until a “point” is established by rolling a 4, 5, 6, 8, 9, or 10, at which time the come-out roll is over. Thus, if the state before roll is come-out, then the state after the roll will still be come-out if a 2, 3, 7, 11, or 12 is rolled. Referring to the roll probabilities from FIG. 22, the corresponding probability for each of these rolls is 1/36, 2/36, 6/36, 2/36, and 1/36 respectively. The sum of the probabilities is 12/36, or 33.33% as indicated in the first cell under the come-out column of FIG. 20. Similarly, if the state before roll is come-out, then the probability that the state will be in the Point-8 state after the roll is the same as the probability of then rolling an eight, which is 5/36, or 13.89%. Likewise, if the state before roll is Point-8, meaning that a shooter has rolled an eight during his come-out roll, then (a) if another eight is rolled (13.89% probability) the next state will be again the come-out state, (b) if a 7 is rolled (16.67% probability) the shooter will lose, and (c) for all other rolls (69.44% remaining probability) the game will still be in the Point-8 state with the shooter hoping to roll an eight.

FIG. 21 is a table illustrating the probability of a particular state after a roll is completed, breaking the probabilities down by the number of rolls by the same shooter. The contents of each cell in the table are calculated using summing the product of the probability for each possible game state from the row above it and multiplying it by the pertinent probability for that game state from the table of FIG. 20. For example, in FIG. 21, the cell in the row for the 4^{th} Roll and the column for Point-5 has a value of 9.22%, and is calculated by multiplying the value in cell (Roll-3, Come-Out) of FIG. 21 by the value in cell (Come-Out, Point-5) of FIG. 20, then summing it with the result from multiplying the value in cell (Roll-3, Lose) of FIG. 21 by the value in cell (Lose, Point-5) of FIG. 20, then summing it with the result from multiplying the value in cell (Roll-3, Point-4) of FIG. 21 by the value in cell (Point-4, Point-5) of FIG. 20, and so on for all of the cells in the row Roll-3, wherein the referenced row and column designations for the cells indicated are: (row, column).

The probability that a shooter will lose by the time a particular roll has been completed is shown in the Lose column of FIG. 21. Thus, the odds of a shooter will still be the shooter after a particular roll is calculated as 1/[1−Lose(n)] where Lose(n) is the Lose probability for roll number n. For example, from the table, Lose(16)=88.65%, a thus the odds the shooter making it through the 16^{th} roll is 141-0.8865)=8.81 as shown in the Odds column for Roll 16. With odds of 8.81:1, if the casino decides to pay out 8:1 for that bet, it will have a House-Edge of 10.1% on that bet based on the ratio of the odds to the payout.

Thus, the table of FIG. 21 shows calculations and specifically highlights results pertaining to using the display to pay odds if a shooter rolls continuously for 7, 16, or 28 times. The odds to be paid are calculated and the casino payouts are calculated in this table. The payout results shown in the “Payout” column are based on a $1 bet for 7 continuous rolls by the same shooter, 16 continuous rolls by the same shooter, and 28 continuous rolls by the same shooter. The “H-Edge” column refers to the house-edge (advantage) on the odds proposed for the bet.

Note that the roll spots and payouts at particular roll spots which are discussed and shown herein in relation to the display 230 are merely exemplary, and any desired roll spots and payout amounts may be used in the game.

The display 230 or 30 helps the box man and dealer when the customer or shooter has questions or a dispute arises. In the case of the display 230 shown and described in relation to FIGS. 16-19, because the past roll data, point to be made, consecutive rolls of the current shooter, and payout amount are shown clearly on the display 230, a dispute or question may be settled or answered by merely viewing the display 230, saving time and trouble and therefore ultimately increasing the profitability of the craps table associated with the display 230. Advantageously shown on both displays 30 and 230 is the past roll data including the last 28 rolls (or however many past rolls are included on the display 30 and 230, which may or may not be 28 rolls, as any number of past rolls may be shown on the display 30 and 230 of embodiments), how many sevens and elevens were rolled, how many rolls it took to win, etc., thereby providing a reference point for the games.

In some embodiments, surveillance may record the display 230 or 30 (e.g., by using one or more cameras to view and capture images of the display and recording equipment to record the images captured by the camera) to allow the table overseer to monitor dealers and customers during and after the game is played. The display 230 or 30 in this manner keeps everyone involved in the craps game honest, including but not limited to the dealer, box man, and customer.

Generally, as described in examples above, a game may be played using the display 230, the game involving one or more customers placing one or more bets on how long a dice shooter will remain the dice shooter. It is understood that the game disclosed herein wherein one or more bets may be placed on whether the same shooter will maintain control of the dice in a craps game for a number of rolls may be playable with or without the display 230 or 30.

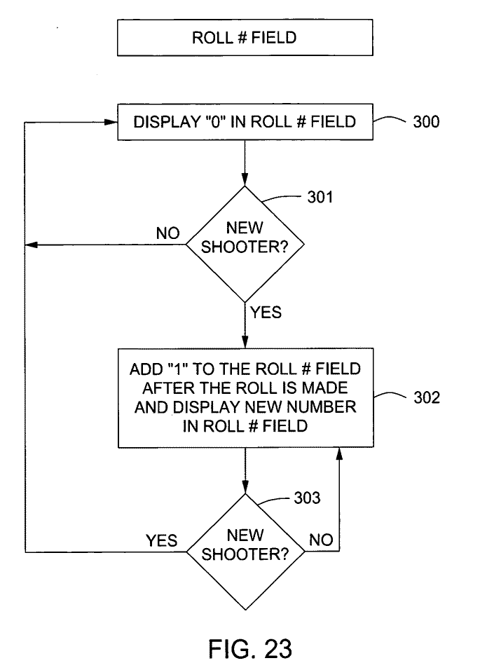

FIG. 23 illustrates an example of operations for displaying a last consecutive roll number for the current shooter in the field 202 in a display 230 for a craps table 32, in accordance with one embodiment. At operation 300, a “0” is initially displayed in the roll number field 202 (in the alternative, instead of a “0”, either no number or nothing at all may appear in the roll number field 202 at this operation 300). Operation 301 determines whether a new shooter has rolled (for instance, as flagged by the stickman or other person using a keypad, as described herein), and if so, in operation 302 a “1” is added to the roll number field 202 after the roll is made, and this number is displayed in the roll number field beneath the words “ROLL #”. Operation 303 then determines whether a shooter has changed (for instance, as flagged by the stickman or other person using a keypad, as described below), and if not, control is passed to operation 302, so that operation 302 adds “1” to the roll number field 202 after the roll is made and the new number is displayed in the roll number field 202. Thus, if operation 303 determines that the shooter has not changed, the number “1” would be added to the roll number “1” already existing in the field 202 and the roll number field 202 would then read “ROLL # 2” after the roll number is made without a change in shooter; subsequently, if operation 303 determines that the shooter has not changed, the number “1” would be added to roll number “2” already existing in the filed 202 and the roll number field 202 would then read “ROLL # 3” after an additional roll number is made without a change in shooter, etc. If the operation 303 determines that the shooter has changed, the roll number field will return to displaying “0” when control is passed to operation number 300.

The following describes an example of operations for displaying the payout in the field 203 in a display 230 for a craps table 32, in accordance with one embodiment. The field 203 displays the payout P on the screen after N consecutive rolls of the dice by the same shooter, where N is a number greater than 0. The field 203 may also display the payout P1 on the screen after N1 consecutive rolls of the dice by the same shooter and/or the payout P2 on the screen after N2 consecutive rolls of the dice by the same shooter. Any number of consecutive rolls of the dice by the same shooter may be set to display a payout on the screen in the field 203 (optionally, N3, N4, etc. may result in a payout P3, P4, etc. display on the screen in field 203). When the same shooter has rolled N consecutive dice pairs without losing roll of the dice (where no “new shooter” is detected after each of the N rolls of the dice), the payout P associated with N is displayed in the field 203. For example, where N is “7” and the payout P is 2 to 1, after 7 rolls of the dice where no “new shooter” is detected (by the “new shooter” detection operation) after each of the 7 rolls of the dice, the payout field 203 will display “PAYS 2 to 1”. Likewise, where N1 is “16” and the payout P1 is 8 to 1, after 16 rolls of the dice where no “new shooter” is detected after each of the 16 rolls of the dice, the payout field 203 will display “PAYS 8 to 1”.

The payout field 203 may operate to display the payout either on its own according to whether a new shooter is detected (by a new shooter detection operation) after each of the N, N1, and/or N2 rolls of the dice by a shooter, or instead may operate in conjunction with the roll number field 202. When operating in conjunction with the roll number field 202, when operation 303 does not detect a new shooter N number of times, the payout P is displayed in the payout field 203.

Other games may be played using the display 230, instead of or in addition to the game described above involving one or more customers placing one or more bets on how long a dice shooter will remain the dice shooter. These other games described in the following paragraphs may be playable with or without the display 230 or 30 or with or without additional display embodiments described in the following paragraphs.

These other games may include one or more games which involve one or more customers placing one or more bets on whether a particular dice shooter will achieve a specified goal without losing possession of the dice. These bets may be placed prior to a first roll by the dice shooter on whom the bets are placed, and the payout on the bets may be determined prior to the first roll by the dice shooter on whom the bets are placed. In some embodiments, the display 230 or 30 may include one or more additional fields with one or more additional indicia to keep track of the current status (e.g., number of rolls of the particular variable involved in the bet) of the shooter and may include one or more additional fields for displaying a payout upon reaching of the goal. It is also within the scope of embodiments that only that particular variable may be displayed in one or more fields on the display 230 or 30, without the other fields disclosed herein being on the display 230 or 30.

Variables which may be displayed on the display 230 or 30 in one of more fields thereon and bets that may be made include how many points will be made “the hard way” by the same shooter without that shooter losing roll of the dice (described below), whether all possible different numbers of points will be made the hard way by the same shooter without that shooter losing possession of the dice, how many doubles will be rolled (or how many of a particular double will be rolled) by the same shooter without that shooter losing roll of the dice, how many times a specified number will be rolled by the same shooter without that shooter losing roll of the dice (either the total number of the pair of dice or the number on one of the dice), and/or whether the shooter will roll a certain number (the certain number being either total of the pair or the number on one of the dice) before he or she loses possession of the dice. Any other variables or bets may be made based on what a shooter will roll or how many times the shooter will roll a number or combination while the same shooter retains possession of the dice without losing control of the dice. The bets may be placed prior to the first roll of the dice of the shooter on whom the bet is placed.

When a bet is placed based on how many points the shooter will make “the hard way” without the shooter losing possession of the dice, the bet is placed on how many points will be made by the shooter by rolling doubles (e.g., a 2, 2; a 3, 3; a 4, 4; etc.). For example, when the point to be made is “8”, the point is made “the hard way” when the shooter rolls a 4, 4 without losing possession of the dice (e.g., rolling “craps”). In one example, a bet may be placed that the same shooter will roll three points the hard way during his roll of the dice without that shooter losing possession of the dice. In this particular exemplary bet, three points to be made must be made by that shooter rolling doubles.

One or more bets may be placed on whether the same shooter will make all different point numbers the hard way (or make at least any number of different point numbers the hard way) without the shooter losing possession of the dice. For example, a bet may be placed on whether the shooter will make at least two different point numbers the hard way without losing possession of the dice, so that the payout on that bet will occur if the same shooter rolls a 1, 1 to make a “2” point and, without losing possession of the dice, also rolls a “2, 2 to make a “4” point.

The one or more bets may be made on the total number of points that will be made the hard way by the same shooter without losing possession of the dice, on the total number of specific points that will be made by the same shooter without losing roll of the dice, and/or on the total number of consecutive points that will be made the hard way by the same shooter without losing possession of the dice. The display 230 or 30 may include one or more fields having indicia indicating how many points (or how many of a particular point) have been made the hard way by the same shooter without losing roll of the dice, or instead or in addition to the one or more fields and/or indicia, the display 230 or 30 may include an indicator beside the dice or incorporated with the dice data displayed on the screen which shows when one or more points have been made the hard way by the shooter, so that it may be easily discerned by all interested parties when a payout on that bet should occur. The payout may also be displayed on the screen once the payout should occur.

One or more bets may be placed by one or more persons on how many of a particular number will be rolled by the same shooter without that shooter losing possession of the dice (e.g., due to rolling “craps”). That particular number may either be the number on one of the dice or the total number present on a pair of dice when the pair of dice is rolled. For example, when the particular number on which the bet is placed is “8” for a pair of dice, each roll of “8” for the pair of dice (for example by rolling 2, 6; 3, 5; or 4, 4) will count towards the total number of 8's which are rolled by that particular shooter. In one example which is not limiting of embodiments, one or more bets may be placed on whether the same shooter will roll at least four 8's without losing roll of the dice. In another example which is not limiting of embodiments, one or more bets may be placed on whether the same shooter will roll at least six 3's on one of the dice of the pair without losing roll of the dice. The one or more bets may be placed prior to the shooter's first roll of the dice.

For the embodiment where one or more bets may be placed on whether the same shooter will roll a particular number a certain number of times without losing possession of the dice, the display 230 or 30 may include one or more fields having indicia indicating how many of a particular number have been rolled by the same shooter without that shooter losing roll of the dice, or instead or in addition to the one or more fields and/or indicia, the display 230 or 30 may include an indicator beside the dice or incorporated with the dice data displayed on the screen which shows when that particular number has been rolled by the shooter. Displaying the data relating to rolling this particular number allows all interested parties to see when a payout on that bet should occur. The payout may also be displayed on the screen once the payout should occur.

The above descriptions of possible bets which may be placed on the dice rolls of the same shooter during his or her continuous possession of the dice without that shooter losing roll of the dice are only exemplary. In addition to or in lieu of the above examples, one or more bets may be placed on any event occurring any number of times while the same shooter retains possession of the dice without that shooter losing roll of the dice. One or more bets may be placed on any play with a single line roll, any single line roll bets, or any combination bets which can be adapted to occurring during the same shooter's continuous roll of the dice, without that shooter losing possession of the dice (e.g., “craps”). One or more bets may be placed on any combination of any number showing up any number of times during the same shooter's continuous roll of the dice without that shooter losing possession of the dice.

Hence, it can be seen that various embodiments of a craps table display 30 and 230 and related system are provided herein.

As disclosed herein, the craps table display 30 and 230 may show data relating to dice pairs rolled in one or more arrangements on the display where a history of each dice pair rolled is displayed on at least a portion or region of the display 30, 230. The one or more arrangements shown in the figures are one or more columns; however, it is within the scope of embodiments for the display to include any type of arrangement of dice pair rolls, for example one or more rows, one or more diagonal arrangements, etc.

In one example which is not limiting of embodiments, the display screen may be a 23-inch color LCD (diagonal) with a view angle of 150 degrees left-to-right and dimensions of 21.7 inches by 15.3 inches by 3.8 inches. In this non-limiting example, the display may have an enclosure of brushed stainless steel, a 6-foot by 2-inch black steel pipe attached thereto, the mounting may be a bolt flange on the pipe end, and power may be 120/220 VAC, 40W.

Embodiments of the invention can be implemented via appropriate software or computer program code instructions in combination with appropriate instruction execution platforms, processor(s), hardware or the like. These instructions may be in the form of a computer program product that can cause a CPU to control operation of a display according to an embodiment of the invention. The combination of hardware and software to perform the functions described can form the means to carry out the processes and/or subprocesses of embodiments of the invention. In this regard, each block in the flowcharts or block diagrams may represent a module, segment, action, or portion of code, which comprises one or more executable instructions or actions for implementing the specified logical function(s). Furthermore, an embodiment of the invention may take the form of a hardware embodiment, a software embodiment (including firmware, resident software, micro-code, etc.) or an embodiment combining software and hardware aspects.

Any suitable computer usable or computer readable medium may be used, taking into account that computer program code to operate a display according to embodiments of the invention may reside at various places during assembly of the display, in addition to on or within a display itself. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device.

In the context of this document, a computer usable or computer readable medium may be any medium that can contain, store, communicate, propagate, or transport the program for use by or in connection with an instruction execution system, platform, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out embodiments of the present invention may be written in an object oriented, scripted or unscripted programming language such as but not limited to Java, Peri, Smalltalk, C++ or the like. However, the computer program code for carrying out embodiments of the present invention may also be written in conventional procedural programming languages, such as the “C” programming language or similar programming languages. It should also be noted that functions and combination of functions described herein can be implemented by special purpose hardware-based systems or operators which perform the specified functions or acts.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment. Furthermore, the particular features, structures or characteristics may be combined as desired in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claimed inventions require more features than are expressly recited in each claim. Each embodiment described herein may contain more than one inventive feature.

While the invention has been particularly shown and described with reference to embodiments thereof, it will be understood by those skilled in the art that various other changes in the form and details may be made without departing from the spirit and scope of the invention.

While the foregoing is directed to embodiments of the present invention, other and further embodiments of the invention may be devised without departing from the basic scope thereof, and the scope thereof is determined by the claims that follow.

1. A method of displaying information related to a craps game played at a craps table, comprising:
providing a display associated with the craps table, the display operable to display one or more arrangements of previous die pairs rolled;
obtaining data relating to a first die pair rolled by a shooter;
storing the data relating to the first die pair;
displaying on the display a representation of the data relating to the first die pair;
obtaining data relating to a number of consecutive die pair rolls made by the shooter without the shooter losing roll of the die; and
indicating on the display an indicator of the number of consecutive die pair rolls made by the shooter without the shooter losing roll of the die.

2. The method of claim 1, further comprising:
prior to obtaining data relating to the first die pair rolled by the shooter, storing a first predetermined number of consecutive die pair rolls which must be made by the same shooter without the shooter losing roll of the die to result in a first payout and storing the first payout associated with the first predetermined number; and
indicating on the display an indicator of the first payout after the number of consecutive die pair rolls made by the shooter without the shooter losing roll of the die equals the first predetermined number of consecutive die pair rolls.

3. The method of claim 2, further comprising:
prior to obtaining data relating to the first die pair rolled by the shooter, storing a second predetermined number of consecutive die pair rolls which must be made by the same shooter without the shooter losing roll of the die to result in a second payout and storing the second payout associated with the second predetermined number; and
indicating on the display an indicator of the second payout after the number of consecutive die pair rolls made by the shooter without the shooter losing roll of the die equals the second predetermined number of consecutive die pair rolls.

4. The method of claim 1, wherein:
the display is operable to display at least two arrangements of previous die pairs rolled, and
the at least two arrangements are at least two columns.

5. The method of claim 4, wherein each of the at least two columns displays different sizes of previous die pairs rolled.

6. The method of claim 1, wherein the representation of the data relating to the first die pair includes a graphic representation of a numeric value of each die of the first die pair.

7. The method of claim 1, wherein the representation of the data relating to the first die pair includes a graphic representation of the face of each die of the first die pair.

8. The method of claim 1, further comprising:
obtaining data relating to a second die pair rolled by a shooter;
storing the data relating to the second die pair;
displaying on the display a representation of the data relating to the second die pair;
obtaining data relating to a number of consecutive die pair rolls made by the shooter without the shooter losing roll of the die; and
indicating on the display an indicator of the number of consecutive die pair rolls made by the shooter without the shooter losing roll of the die.

9. The method of claim 8, further comprising:
prior to obtaining data relating to the first die pair rolled by the shooter, storing a first predetermined number of consecutive die pair rolls which must be made by the same shooter without the shooter losing roll of the die to result in a first payout and storing the first payout associated with the first predetermined number; and
indicating on the display an indicator of the first payout after the number of consecutive die pair rolls made by the shooter without the shooter losing roll of the die equals the first predetermined number of consecutive die pair rolls.

10. The method of claim 8, further comprising:
locating the representation of the data relating to the first die pair below the representation of the data relating to the second die pair.

11. The method of claim 8, further comprising:
displaying in a first location on the display the representation of the data relating to the first die pair;
moving the representation of the data relating to the first die pair to a second location on the display; and
displaying in the first location the representation of the data relating to the second die pair.

12. A display for a craps table, comprising:
a first display portion operable to display a representation of data relating to a current die pair rolled by a shooter;
a second display portion operable to display a representation of data relating to previous die pairs rolled; and
a third display portion operable to display an indicator of a number of consecutive die pairs rolled made by the shooter without the shooter losing roll of the die.

13. The display of claim 12, further comprising:
a fourth display portion operable to display an indicator of a payout achieved after a predetermined number of consecutive die pairs are rolled by the shooter without the shooter losing roll of the die.

14. A method for using displayed information related to a craps game played at a craps table, comprising:
providing a display associated with the craps table, the display operable to display one or more arrangements of previous die pairs rolled;
allowing one or more persons to place one or more bets that a shooter will make a first predetermined number of consecutive die pair rolls without the shooter losing roll of the die;
obtaining data relating to a first die pair rolled by the shooter;
storing the data relating to the first die pair;
displaying on the display a representation of the data relating to the first die pair;
obtaining data relating to a number of consecutive die pair rolls made by the shooter without the shooter losing roll of the die; and
indicating on the display an indicator of the number of consecutive die pair rolls made by the shooter without the shooter losing roll of the die.

15. The method of claim 14, further comprising:
providing a first payout to the one or more persons if the shooter reaches the first predetermined number of consecutive die pair rolls without the shooter losing roll of the die.

16. The method of claim 14, further comprising:
indicating on the display an indicator showing the first payout if the shooter reaches the first predetermined number of consecutive die pair rolls without the shooter losing roll of the die.

17. The method of claim 14, further comprising:
prior to allowing one or more persons to place one or more bets that the shooter will make a first predetermined number of consecutive die pair rolls without the shooter losing roll of the die, storing a first predetermined number of consecutive die pair rolls which must be made by the same shooter without the shooter losing roll of the die to result in a first payout and storing the first payout associated with the first predetermined number.

18. The method of claim 17, further comprising:
allowing one or more persons to place one or more bets that the shooter will make a second predetermined number of consecutive die pair rolls without the shooter losing roll of the die.

19. The method of claim 18, further comprising:
prior to allowing one or more persons to place one or more bets that the shooter will make a second predetermined number of consecutive die pair rolls without the shooter losing roll of the die, storing a second predetermined number of consecutive die pair rolls which must be made by the same shooter without the shooter losing roll of the die to result in a second payout and storing the second payout associated with the second predetermined number; and
indicating on the display an indicator showing the second payout if the shooter reaches the second predetermined number of consecutive die pair rolls without the shooter losing roll of the die.

20. The method of claim 19, further comprising providing the second payout to the one or more persons who placed one or more bets that the shooter will make the second predetermined number of consecutive die pair rolls without the shooter losing roll of the die, if the shooter reaches the second predetermined number of consecutive die pair rolls without the shooter losing roll of the die.

21. A method for using displayed information related to a craps game played at a craps table, comprising:
providing a display associated with the craps table, the display operable to display one or more arrangements of previous die pairs rolled;
allowing one or more persons to place one or more bets that a first event will occur a certain number of times during roll of a pair of die by a shooter without the shooter losing roll of the die;
obtaining data relating to a first die pair rolled by the shooter;
storing the data relating to the first die pair;
displaying on the display a representation of the data relating to the first die pair;
obtaining data relating to a number of times the first event occurs during roll of the die by the shooter without the shooter losing roll of the die; and
indicating on the display an indicator of the number of times the first event occurs during roll of the die by the shooter without the shooter losing roll of the die.

22. The method of claim 21, wherein the first event comprises the shooter making a point a hard way by rolling a double that equals that point.

23. The method of claim 21, wherein the first event comprises the shooter making a specified point number a hard way by rolling a double that equals that point.

24. The method of claim 21, wherein the first event comprises the shooter rolling a die pair total of a specific number.

25. The method of claim 21, wherein the first event comprises the shooter rolling a specific number on one of the dice of the die pair.

26. The method of claim 21, further comprising:
prior to allowing one or more persons to place one or more bets that a first event will occur a certain number of times during roll of a pair of die by a shooter without the shooter losing roll of the die, storing the predetermined number of times which the first event must occur while the shooter retains possession of the die without the shooter losing roll of the die to result in a first payout; and
storing the first payout associated with the first predetermined number of times.
